(19) United States
(12) Patent Application Publication
(10) Pub. No.: US 2016/0033221 A1
(43) Pub. Date: Feb. 4, 2016

(54) FIREARM ACCESSORY

(71) Applicants: Stewart Jacob SCHMEHL, Pinehurst, NC (US); Peter James HAMANN, Fayetteville, NC (US); Jacob Stewart SCHMEHL, Lake Hopatcong, NJ (US)

(72) Inventors: Stewart Jacob Schmehl, Pinehurst, NC (US); Peter James Hamann, Fayetteville, NC (US); Jacob Stewart Schmehl, Lake Hopatcong, NJ (US)

(21) Appl. No.: 14/776,904

(22) PCT Filed: Mar. 14, 2014
(86) PCT No.: PCT/US14/29740

§ 371 Date: Sep. 15, 2015

Related U.S. Application Data
(60) Provisional application No. 61/788,242, filed on Mar. 15, 2013.

(51) Int. Cl. F41A 17/06; G01S 19/13

(52) U.S. Cl. CPC F41A 17/063; G01S 19/13

(57) ABSTRACT

An accessory device useful for any of training, compliance, safety, and accountability of individuals in the use of firearms. An embodiment comprises a circuit board and housing with a means for attaching the accessory to a firearm. The circuit board may comprise an inertial measurement unit (IMU), a GPS receiver, memory to store data, a means for transmitting data, and a microprocessor unit for controlling operations of the printed circuit board. The IMU may comprise a gyroscope, accelerometer, and magnetometer. The accessory can provide position and movement data of such accuracy as to disclose, after transmission and analysis, a firearm user's stability prior to and during discharge, how well the user managed recoil from the discharge, and how quickly the user returned to a starting position following discharge. A reviewer may also be able to discern movements such as those caused by a user's breathing or involuntary muscle contractions.

### BACKGROUND OF THE INVENTION

Police departments, military organizations, and contracted security companies conduct basic weapons training for newly hired personnel who may have need to use such weapons in the course of their jobs. There also is a need on the part of these organizations to have continued practice and training to ensure maintenance of these skills.

Training for firearm skills and tactics is often accomplished using simulated or virtual reality training systems. Such systems generally use simulated weapons that collect field data to later provide reports regarding the users' performances. These weapons often are not intended for field use and do not have the look and feel of the actual weapon used by the user in the field. While the data they collect during a training session may be useful, they do a disservice to the user in light of the differences between these and actual weapons.

Other training methods may incorporate tracking movements while dry or live firing real weapons, but they do not incorporate GPS tracking. Such tracking would be useful for a number of reasons, including increased accountability and heightened safety.

There is a need in the field of firearm training to provide an accessory device that can be used with any firearm to collect, store, and process data that can be useful in training, compliance, accountability, and safety.

### SUMMARY

The subject invention provides an accessory device suitable for training, compliance, and accountability of individuals in the use of firearms. An accessory in accordance with an embodiment of the subject invention may include a circuit board enclosed in a housing with means for attaching the accessory to a firearm. The circuit board may include an inertial measurement unit (IMU), a GPS receiver, memory to store data, a data transmitter for transmitting data, and a microprocessor unit for controlling operations of the printed circuit board. The IMU may incorporate a gyroscope, accelerometer, and magnetometer. When equipped with such an IMU, the accessory can provide position and movement data of such accuracy as to disclose, after transmission and analysis, a firearm user's stability prior to and during discharge, how well the user managed recoil from the discharge, any downward motion in anticipation of a recoil, and how quickly the user returned to a starting position following discharge. The discharge that is able to be tracked may include dry firing as well as firing live or blank ammunition. Additional information may be discerned from analysis of the data including, for example, information concerning a firearm user's involuntary physical movements shortly before, during, or after discharge of a firearm, such as those caused by a user's breathing, heartbeat, or involuntary muscle contractions.

### BRIEF DESCRIPTION OF THE DRAWINGS

FIG. 1 depicts an embodiment of a printed circuit board (PCB) for use in a firearm accessory with various integrated circuits.

FIG. 2 depicts a firearm accessory that incorporates the PCB of FIG. 1 mounted in a housing with an embodiment of a gun rail attachment.

FIG. 3 is a perspective view of the firearm accessory of FIG. 2 attached to the gun rail of a typical pistol.

FIG. 4 depicts an embodiment of a visual display showing live feedback resulting from use of the firearm assembly.

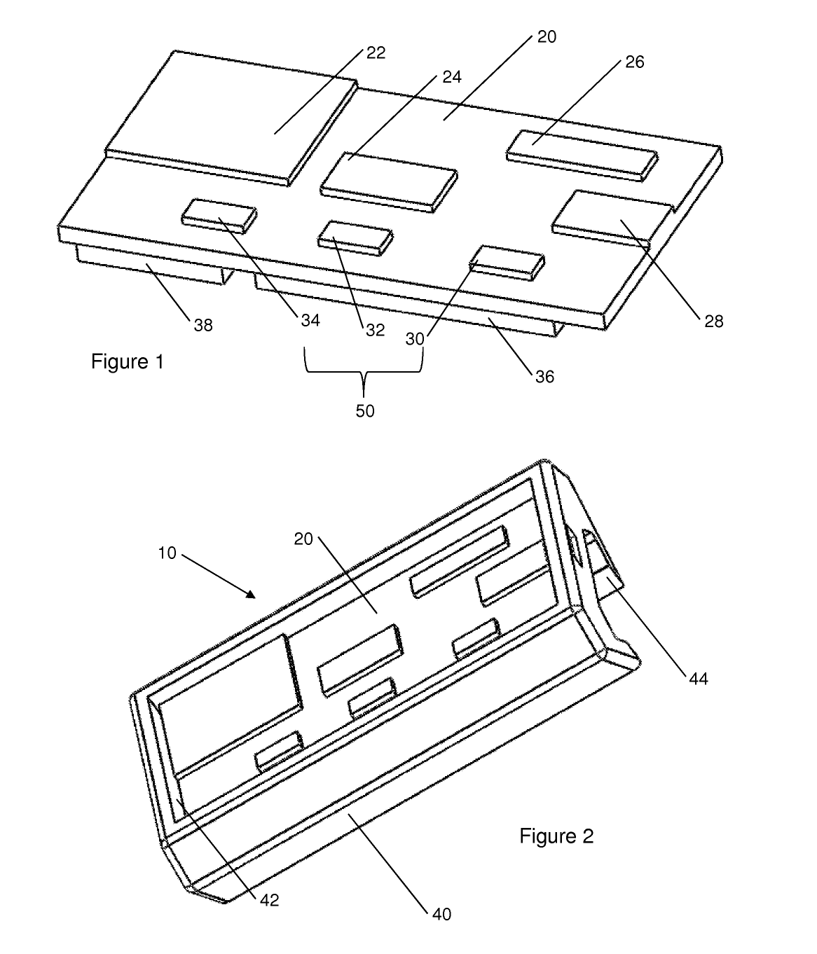

### DETAILED DESCRIPTION

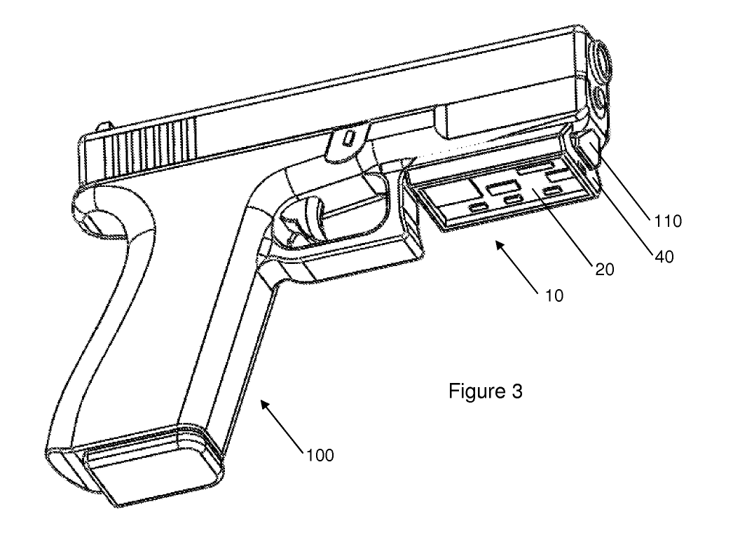

An embodiment of the inventive firearm accessory is described hereafter with reference to the figures. The inventive embodiment, firearm accessory 10, is designed to serve a variety of purposes relating to tracking the use of a firearm 100. The accessory 10, as shown in FIGS. 2 and 3, includes a printed circuit board 20 and a housing 40.

The housing 40 houses the printed circuit board 20 and secures it to the firearm 100. In the depicted embodiment, the housing 40 may have an opening 42 within which the circuit board 20 may be secured. The housing 40 further has a fastener for securing the accessory 10 to a firearm 100. The fastener 44 used in the instant embodiment, as depicted in FIGS. 2 and 3, is an accessory rail mount for attachment to an accessory rail 110. Alternative fasteners for securing the housing to a firearm may be used instead of or in addition to an accessory rail mount. For example, the accessory 10 may be attached to the firearm 100 by sliding the accessory 10 onto the accessory rail 110 and then further secured to the accessory rail 110 by threading a screw (not shown) through the housing 40 and into the accessory rail 110. Inclusion of such an additional fastener will make it more time consuming to remove the accessory 10, thus encouraging users to leave the accessory 10 in place at all times. Having the accessory 10 in place at all times is desirable for use of the accessory 10 in compliance and accountability for security personnel. When the accessory 10 is secured by the fastener 44 to the firearm 100, the printed circuit board 20 will be maintained in a substantially fixed position relative to the firearm 100 during use, so that measurement and/or tracking devices (described hereafter) located on the printed circuit board 20 will accurately reflect movement, position, or other measured characteristics of the firearm 100 itself.

The accessory 10 may also further include a mechanism for turning power to the accessory on and off to conserve battery power. A nonexhaustive list of such mechanisms, which optionally may be used in connection with a specialty holster, includes a mechanical or electromechanical switch, a sleep timer, or a proximity switch, such as a Magnetic Reed switch or a Hall Effect sensor. In an embodiment utilizing a Hall effect sensor as a proximity switch, a magnet may be housed within, for example, the accessory 10 with the sensor itself housed within a holster for housing the firearm 100 with the accessory 10 attached; the alternative, wherein a magnet would be housed within a holster and a sensor within the accessory 10, is also an option. A Hall Effect sensor consists of a piece of semiconductor material which passes a continuous current through itself. While the sensor is within a magnetic field, the field exerts a force on the material to deflect charge carriers to either side of the semiconductor material, creating a voltage output. When the magnetic field is removed by moving the magnet, in this instance within the accessory 10, out of range of the sensor, the voltage output disappears. The microprocessor unit 24 may be programmed to detect the loss of voltage, thus providing information capable of signaling the accessory 10 to turn on and begin recording data as it is removed from the sensor within the holster. Alternatively, a Magnetic Reed switch may be used in essentially the same manner.

The housing 40 in this embodiment is preferably manufactured of a lightweight but durable material; a nonexhaustive list of such materials would include aluminum as well as plastics, for example polycarbonate/acrylonitrile butadiene styrene (PC/ABS), which often is used for mobile phone bodies and for interior and exterior parts of motor vehicles. The housing 40 may have a low profile so as to decrease its weight and noticeability. Often it is preferable that the accessory 10 be detectable but not especially noticeable such that a user may forget the accessory 10 is attached to firearm 100.

The printed circuit board 20 of this embodiment incorporates various components, a non-exhaustive description of which follows hereafter. The printed circuit board 20 may include at least one communications unit, which may be a transceiver (for example a Bluetooth transceiver 22) or in some circumstances merely a one-way communication device; a non-exhaustive list of communication units that might be utilized in the invention may include a Bluetooth transceiver, a Bluetooth transmitter, a radio-frequency transceiver, a radio-frequency transmitter, a WiFi transceiver, and a WiFi transmitter. The printed circuit board further includes at least one microprocessor unit 24 to control operations of the printed circuit board, including processing data from the attached sensors (described below), and memory 26, which is a non-transitory processor-readable medium configured for storing data from the attached sensors. The printed circuit board 20 further may incorporate an energy source, such as a battery 36. The printed circuit board 20 may further include a typical battery charging circuit to allow recharging of the battery 36 through connecting the circuit to a power source. As well known to those skilled in the art, these battery charging circuits are readily available from a variety of sources and may be integrated in a variety of manners. The printed circuit board further may include a clock. The clock may be incorporated into the microprocessor unit 24 or may be separately provided.

The printed circuit board 20 further includes one or more sensors for detecting position with respect to the earth, velocity, and orientation or attitude (often referred to as roll, pitch and yaw), and for outputting data corresponding thereto, such one or more sensors hereafter referred to as an inertial measurement unit (IMU) 50. The IMU 50 may incorporate additional sensors for detecting additional aspects of intertial motion. In the depicted embodiment, the IMU 50 has a three-axis magnetometer 30, a three-axis accelerometer 32, and a three-axis gyroscope 34. The magnetometer 30 acts as a compass and provides information relating to the absolute orientation of the accessory 10 in the north-south-east-west plane; because it is a three-axis device, the magnetometer 30 does not depend on orientation or elevation in order to provide accurate data. The accelerometer 32 measures acceleration and thus provides measurable information regarding the changes in velocity (i.e., acceleration) and changes in position. Incorporation of a three-axis accelerometer 32 allows it to act as an absolute orientation sensor with respect to a three-dimensional coordinate system in a gravitational field. The gyroscope 34 measures the angular rates of rotation about the pitch (x), roll (y), and yaw (z) axes. The combination of these sensors 30, 32, 34 allows for quick and accurate position and orientation determination with a low amount of accumulated error over time and caused by relatively small movements (e.g., involuntary muscle contractions).

One disadvantage to relying upon an IMU 50 is that they ordinarily suffer from accumulated errors. The unit continually adds detected changes to its previously-determined positions such that any errors in measurement are accumulated. This results in an ever-increasing difference between the calculated location of the IMU 50 and its actual location. In order to limit accumulated error, the circuit board 20 may further incorporate a secondary means for location, such as additional sensors, a magnetic compass, or, as shown in the depicted embodiment, a GPS receiver 38. The GPS receiver 38 deduces its location through trilateration. (It should be noted that the GPS receiver 38 of this embodiment has a communications unit dedicated to the work of the GPS, and that a different communications unit, Bluetooth receiver 22, is used for communication with the reviewer as later described.)

In the depicted embodiment, the accelerometer 32 and gyroscope 34 provide data that is processed as quaternion data. The quaternion defines a four-dimensional vector (x, y, z, w), which is used to efficiently describe the rotation of the accessory 10, and thus the attached firearm 100, about the position vector (x, y, z). The data provided by the magnetometer 30 is processed to provide heading data with respect to the earth's magnetic field. The data from the GPS receiver 38 is processed to provide position with respect to the earth's latitude and longitude coordinates as well as real time with respect to GMT. The combination of the processed data allows for the absolute position and orientation of the firearm 100 to be determined.

The precision of the data accumulated from the combination of the IMU 50 and GPS receiver 38 allows the accessory 10 to detect extremely small movements of the firearm. These movements may be transmitted via a communications unit such as Bluetooth transceiver 22 to an external device (e.g., computer, tablet, smart phone) for analysis and may be accessed and used in a variety of ways. For example, in an accessory 10 dedicated to providing an employer the ability to monitor a user's use of a firearm 100 with respect to complying with training requirements, the microprocessor unit 24 may be programmed to detect arrival of the firearm 100 at the user's place of employment and to automatically download data relating to the user's compliance activities to a central server. In some embodiments, the microprocessor unit 24 may be programmed so that a particular code must be entered in order to modify the data stored in the memory 26, thus preventing a firearm user without the proper authorization from tampering with the data.

The data collected from the use of the accessory 10 may be used for accountability purposes. Professionals who handle weapons as part of their jobs often are required to complete certain training exercises in order to maintain their skill level. For example, a police officer may be required to complete three re-qualification shoots each year, each of which must be more than 60 days apart and during each of which the officer is required to fire a certain number of rounds in target practice. Data collected by the IMU 50 will indicate that the firearm has been discharged (for example, the sensors sense and provide data showing movement of the firearm associated with discharge), as well as information relating to orientation of the firearm at various times during the firing process, including shortly before discharge as the firearm is aimed, during discharge, and shortly following discharge while the user reacts to the recoil and repositions the firearm for the next shot. The data from the GPS augments this information. The accessory 10 can collect and provide data to corroborate that a police officer using the firearm 100 completed the requisite training by detecting and recording each discharge of the attached firearm 100 as well as the time, date, and location of each discharge. Moreover, the data provided by the accessory 10, which in this embodiment includes data recording the sensed orientation of the firearm during discharge, will be sufficiently detailed to reflect that the firearm user repeatedly took aim at a target other than the ground, thus discouraging the user from simply discharging the firearm 100 into the ground to quickly simulate the required training exercise.

The data collected from the use of the accessory 10 may be used for training purposes. The IMU 50 and GPS receiver 38 will provide position and movement data of sufficient accuracy that, once this data has been transmitted to an external source and presented for review, the reviewer may be able to determine areas in which use of the firearm 100 may be improved. For example, the data may reflect the firearm user's stability prior to and during discharge, how well the user managed recoil from the discharge, how quickly the user returned the firearm 100 to a position for shooting at a target following discharge, and time between discharges. The user's movements may be compared to ideal use such that the user may be informed of the differences between his performance and an ideal performance. The user may have the opportunity to review this data through the use of software programmed to receive and analyze the data and visually and/or aurally provide feedback regarding the data. The software may be installed by the user on a computing device or it may be an application that interacts with a web-based server to analyze the data. Through the software, the user may be provided a means to share the data through social networking to compare and discuss his performance with others.

The data collected from the use of the accessory 10 may be used to provide corroborating evidence of any discharge of the firearm 100 in the field, such as information collected by black boxes in airplanes. The IMU 50 and GPS receiver 38 will provide position and movement data of sufficient accuracy that, once this data has been transmitted to an external source and presented for review, the reviewer may be able to determine, for example, the number and time of discharges, the direction of the discharges, the time between multiple discharges, and the absolute location of the discharges. In situations requiring the use of weapons, participants and observers often misremember events. The data provided by the accessory 10 may act as an unbiased witness to such events.

In cases in which the identity of a shooter is contested, data collected from the use of the accessory 10 may be used to identify a shooter of the firearm 100 to which it is attached. The IMU 50 and the GPS receiver 38 can be selected to provide position and movement data that is extremely accurate such that, once this data has been transmitted to an external source and presented for review, the reviewer may discern movements such as those caused by a shooter's breathing, movements such as those caused by a shooter's involuntary muscle contractions, the shooter's stability prior to and during discharge, how well the shooter managed recoil from the discharge, or how quickly the shooter returned to a starting position following discharge. This data may effectively identify an individual. The data from the accessory 10 may also provide information to assist in determining which person from a group of people was responsible for the discharging of the firearm 100. For example, the data may provide sufficient information to approximate the weight of a shooter by analyzing recoil data, to approximate the height of a shooter by analyzing height from the ground at discharge, or to at least rule out certain suspects based upon the height and/or angle of discharge or how well the shooter managed the recoil following the discharge.

The data collected from the use of the accessory 10 may also reflect removal of the accessory 10 from the firearm 100. This information may be useful under a variety of circumstances. With accessory 10, there is no need for a separate removal detection device since the movements associated with removal will be recorded and can be readily interpreted. However, the accessory 10 may include a further means for detecting whether the accessory 10 has been removed from the firearm 100. There are a number of options for such detection, including but not limited to incorporation of a holographic sensor, optical sensor, mechanical or electromechanical sensor, or a proximity sensor such as a Hall effect sensor or Reed switch. The incorporation of a removal detection sensor may be particularly helpful when the accessory 10 is being used for compliance and accountability. For example, should a police officer in the field remove the accessory 10, this may be an indication that the officer is making use of the firearm 100 to which it is attached in a manner that would not be approved by the department.

The data collected from the use of the accessory 10 may be supplemented through coordination with additional accessories, such as grip or trigger sensors. These sensors may provide enhanced data for more effective targeting and firing of weapons, such as monitoring the user's pulse, and/or they may provide additional safety and compliance measures as they could be used to verify the user's identity.

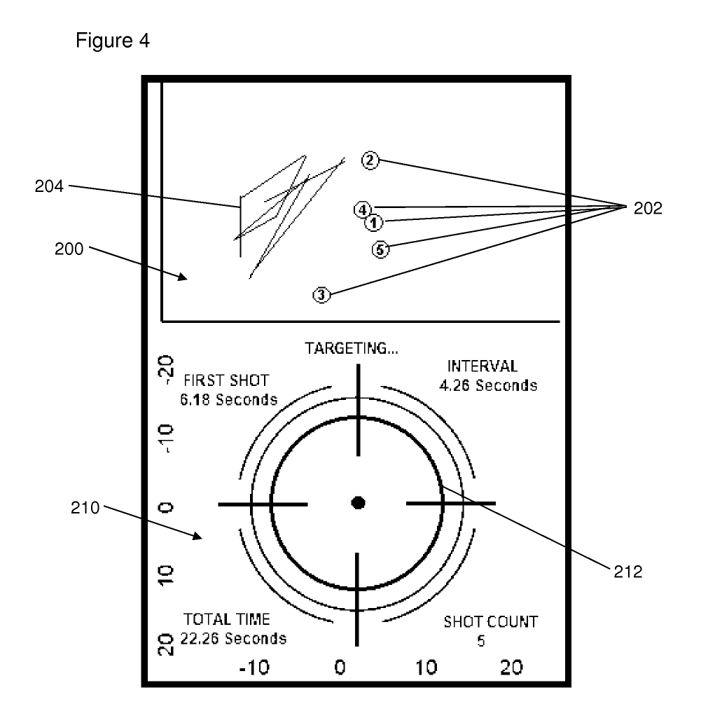

The data collected from the use of the accessory 10 may also be used to provide immediate feedback, such as predictive grouping, alignment of a firearm 100 with the original discharge during successive discharges, or advice regarding use, to the user. For example, the IMU 50 and GPS receiver 38 may collect data that's transmitted by the Bluetooth transceiver 22 to an external device, such as a computer, tablet, smart phone, or even a sight secured to the firearm 100, that has a software application installed to receive the data and provide immediate feedback regarding the user's handling of the firearm 100. In one embodiment, an example of which is represented in FIG. 4, a software application may provide a visual display representing the data collected during use of the firearm accessory 10. The depicted display shows a live display area 200 with hit reports 202 to represent shots fired and a tracking line 204 representing the user's movement during targeting. A targeting display area 210 may provide additional real-time feedback to a user by, for example, changing the color of the sight display 212 when the user has aligned the firearm 100 with the previous shot.

The accessory 10 may also work together with components contained within a holster (not shown) in order to provide certain functionality. For example, the communication unit, such as a Bluetooth transceiver 22, may communicate with a receiver contained within a holster. The receiver may then transmit the data via a WiFi, radiofrequency, cellular, or GSM transmitter. This would allow for reduction of weight within the accessory 10 as the components themselves would not be necessary and the accessory 10 would be able to operate without using as much battery power.

The accessory 10 may also work with components contained within a holster containing a wireless charger capable of charging the battery 36. This will provide for extended use of the accessory 10 without having to remove the accessory 10 from the firearm 100 to recharge or replace the battery 36.

The foregoing details are exemplary only. Other modifications that might be contemplated by those of ordinary skill in the art are within the scope of this invention, and are not limited by the examples illustrated herein.

What is claimed is:

1. A firearm accessory for monitoring the use of a firearm, comprising at least one battery and at least one printed circuit board,
a. said at least one printed circuit board comprising:
i. an inertial measurement unit,
ii. a non-transitory processor-readable medium configured to store data,
iii. a communication unit configured to transmit data,
iv. a microprocessor unit configured to control operations of the printed circuit board, and
v. a GPS receiver capable of identifying the location of the firearm accessory;
b. said at least one printed circuit board configured to record and store data measured by the inertial measurement unit and GPS receiver, said data comprising:
i. indicia that the firearm has been discharged, and
ii. location, orientation, and movement of the firearm during at least one of shortly prior to discharge of the firearm, during discharge of the firearm, and shortly following discharge of the firearm.

2. The firearm accessory of claim 1 wherein the inertial measurement unit comprises a 3-axis gyroscope and a 3-axis accelerometer.

3. The firearm accessory of claim 2 wherein the inertial measurement unit further comprises a 3-axis magnetometer.

4. The firearm accessory of claim 1 wherein the communication unit is selected from the group comprising at least one of a Bluetooth transceiver, a Bluetooth transmitter, a radio-frequency transceiver, a radio-frequency transmitter, a WiFi transceiver, and a WiFi transmitter.

5. The firearm accessory of claim 1, further comprising a housing enclosing the printed circuit board, wherein the housing further comprises an accessory rail mount.

6. The firearm accessory of claim 1, further comprising a power conservation mechanism selected from the group comprising at least one of a mechanical switch, an electromechanical switch, a sleep timer, and a proximity switch.

7. The firearm accessory of claim 1, further comprising a removal detection sensor selected from at least one of a holographic sensor, optical sensor, mechanical or electromechanical sensor, and a proximity sensor.

8. The firearm accessory of claim 1, said accessory further comprising a battery charging circuit for recharging the battery by connection to a power source.

9. A firearm accessory kit for monitoring the use of a firearm, comprising a firearm accessory and a specialty holster for receiving a firearm with the firearm accessory attached,
a. the firearm accessory comprising at least one battery and at least one printed circuit board,
i. said at least one printed circuit board comprising:
1. an inertial measurement unit,
2. a non-transitory processor-readable medium configured to store data,
3. an accessory communication unit configured to transmit data,
4. a microprocessor unit configured to control operations of the printed circuit board, and
5. a GPS receiver capable of identifying the location of the firearm accessory;
ii. said at least one printed circuit board configured to record and store data measured by the inertial measurement unit, said data comprising:
1. indicia that the firearm has been discharged, and
2. location, orientation, and movement of the firearm during at least one of shortly prior to discharge of the firearm, during discharge of the firearm, and shortly following discharge of the firearm;
b. the specialty holster comprising a holster communication unit capable of receiving data from the accessory communication unit and capable of transmitting data.

10. The firearm accessory kit of claim 9 wherein the inertial measurement unit comprises a 3-axis gyroscope and a 3-axis accelerometer.

11. The firearm accessory kit of claim 10 wherein the inertial measurement unit further comprises a 3-axis magnetometer.

12. The firearm accessory kit of claim 9 wherein the accessory communication comprising at least one of a Bluetooth transceiver, a Bluetooth transmitter, a radio-frequency transceiver, a radio-frequency transmitter, a WiFi transceiver, and a WiFi transmitter.

13. The firearm accessory kit of claim 9 wherein the holster communication unit comprises at least one of a Bluetooth transceiver, a Bluetooth transmitter, a radio-frequency transceiver, a radio-frequency transmitter, a WiFi transceiver, and a WiFi transmitter.

14. The firearm accessory kit of claim 9, the firearm accessory further comprising a housing enclosing the printed circuit board, wherein the housing further comprises an accessory rail mount.

15. The firearm accessory kit of claim 9, the firearm accessory further comprising a power conservation mechanism comprising at least one of a mechanical switch, an electromechanical switch, a sleep timer, and a proximity switch.

16. The firearm accessory kit of claim 9, the firearm accessory further comprising a removal detection sensor selected from at least one of a holographic sensor, optical sensor, mechanical or electromechanical sensor, or a proximity sensor.

17. The firearm accessory kit of claim 9, the firearm accessory further comprising a battery charging circuit for recharging the battery by connection to a power source.

18. The firearm accessory kit of claim 17, the holster further comprising a wireless battery charger capable of charging the at least one battery of the firearm accessory.

19. A method of monitoring use of a firearm, comprising
a. providing to a user a firearm comprising a printed circuit board, said printed circuit board further comprising:
i. an inertial measurement unit,
ii. a non-transitory processor-readable medium configured to store data and to store the time of receipt of said data,
iii. a communication unit configured to transmit data,
iv. a microprocessor unit configured to control operations of the printed circuit board, and
v. a GPS receiver capable of identifying the location of the firearm accessory;
b. causing measurements taken by the inertial measurement unit during use of the firearm by the user to be recorded on the non-transitory process-readable medium, said measurements comprising:
i. indicia that the firearm has been discharged, and
ii. location, orientation, and movement of the firearm during at least one of shortly prior to discharge of the firearm, during discharge of the firearm, and shortly following discharge of the firearm, and
c. receiving from the communication unit the recorded measurements.
